(19) United States
(12) Patent Application Publication
(10) Pub. No.: US 2015/0152945 A1
(43) Pub. Date: Jun. 4, 2015

(54) SINGLE AXIS ROBOT

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventor: YUN ZHAO, Shenzhen (CN)

(21) Appl. No.: 14/537,270

(22) Filed: Nov. 10, 2014

(30) Foreign Application Priority Data
Nov. 29, 2013 (CN) 201310619266.X

(51) Int. Cl. F16H 25/12; B25J 9/10; B25J 9/02

(52) U.S. Cl. CPC F16H 25/12; B25J 9/02; B25J 9/104; Y10S 901/21

(57) ABSTRACT

A single axis robot includes a frame, a driving mechanism coupled to the frame, a guiding mechanism coupled to the driving mechanism, and a hermetic band. The guiding mechanism include a platform coupled to the driving mechanism, a guiding frame mounted on the platform, a first guiding roller, two second guiding rollers, and an adjusting assembly. The first guiding roller and the second guiding rollers are arranged on the guiding frame. The first guiding roller has a first inclined surface at each end thereof. The adjusting assembly includes two adjusting blocks and two adjusting members. Each adjusting member is adjustably coupled to the guiding frame and fixed to one of the adjusting blocks. Each adjusting block has a second inclined surface resisting the first inclined surface. The hermetic band is coupled to the frame and winds on the first guiding roller and the second guiding rollers.

### FIELD

The subject matter herein generally relates to robots, and particularly to a single axis robot.

### BACKGROUND

Single axis robots can be used to drive a workpiece to achieve linear movement. To avoid dusts, water, or oil to enter into the single axis robots, the single axis robots need to be designed in a sealed structure.

### BRIEF DESCRIPTION OF THE DRAWINGS

Implementations of the present technology will now be described, by way of example only, with reference to the attached figures.

FIG. 1 is an isometric view of an embodiment of a single axis robot including a guiding mechanism.

FIG. 2 is an exploded, isometric view of the single axis robot of FIG. 1.

FIG. 3 is a partially assembled isometric view of the single axis robot of FIG. 1.

FIG. 4 is a partially exploded isometric view of the single axis robot of FIG. 3.

FIG. 5 is an enlarged view of a circle V of the single axis robot of FIG. 4.

FIG. 6 is a partial isometric view of the guiding mechanism of the single axis robot of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is in relation to a single axis robot and can include a frame, a driving mechanism coupled to the frame, a guiding mechanism coupled to the driving mechanism, and a hermetic band. The guiding mechanism can be configured to move linearly driven by the driving mechanism. The guiding mechanism can include a platform coupled to the driving mechanism, a guiding frame mounted on the platform, a first guiding roller, two second guiding rollers, and an adjusting assembly. The first guiding roller and the second guiding rollers can be arranged spaced and parallel to each other on the guiding frame. The second guiding rollers can be positioned at opposite sides of the first guiding roller. The first guiding roller can have a first inclined surface at each end thereof. The adjusting assembly can include two adjusting blocks and two adjusting members. Each adjusting member can be adjustably coupled to the guiding frame and fixed to one of the adjusting blocks. Each adjusting block can have a second inclined surface resisting the first inclined surface. The hermetic band can be coupled to the frame and wind on the first guiding roller and the second guiding rollers to seal the frame.

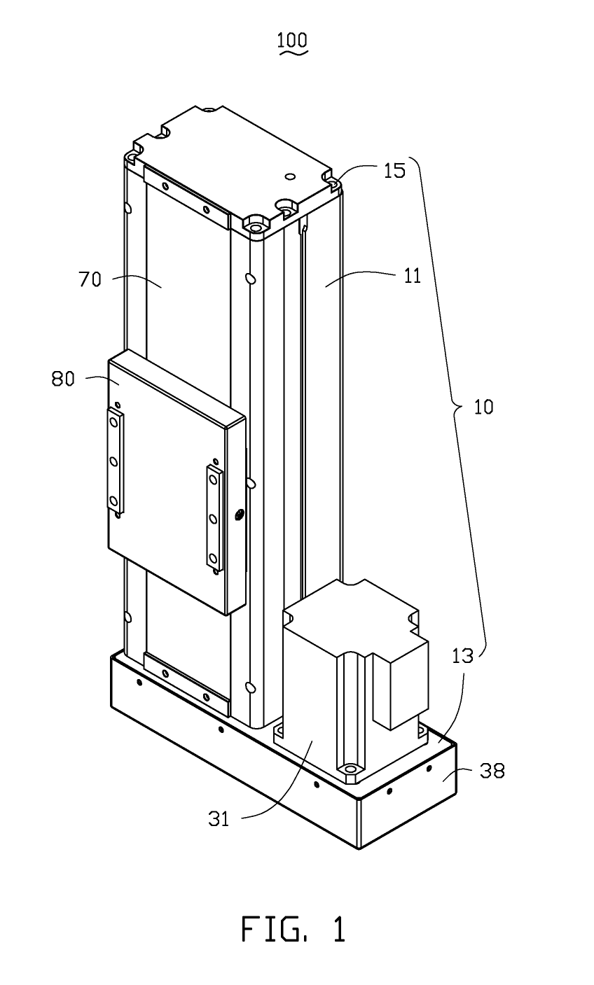

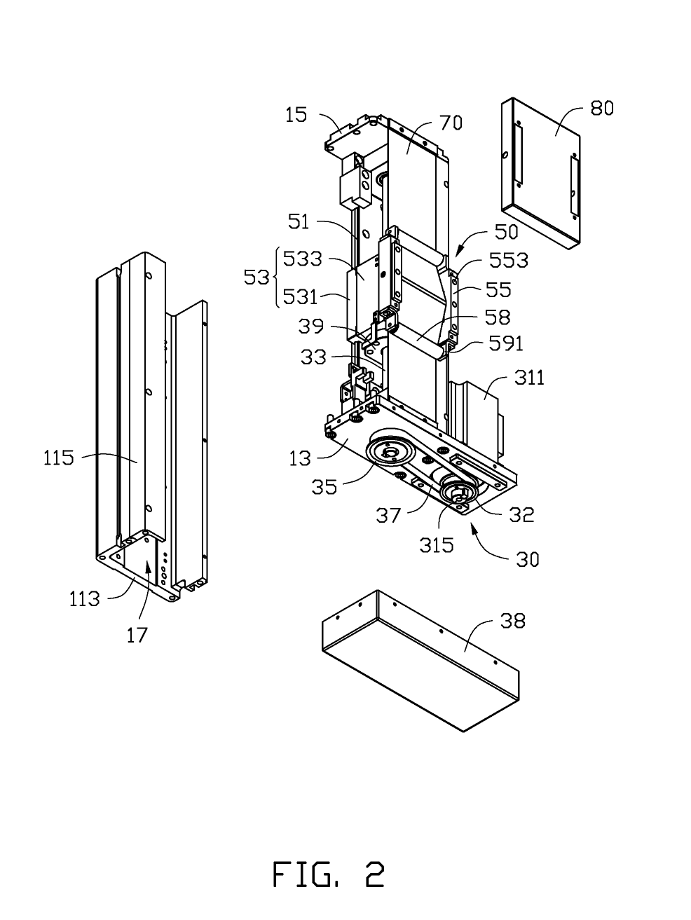

FIG. 1 illustrates an embodiment of a single axis robot 100. The single axis robot 100 can include a frame 10, a driving mechanism 30, a guiding mechanism 50, a hermetic band 70, and a protective cover 80. The frame 10 can be configured to support and install the driving mechanism 30, the guiding mechanism 50, the hermetic band 70, and the protective cover 80. FIG. 2 illustrates that the driving mechanism 30 can be coupled to the frame 10. The guiding mechanism 50 can be coupled to the driving mechanism 30. The driving mechanism 30 can move the guiding mechanism 50 linearly. The hermetic band 70 can be coupled to the frame 10 and configured to seal the frame 10. The protective cover 80 can cover and protect the guiding mechanism 50. In the illustrated embodiment, the single axis robot 100 is a linear robot.

The frame 10 can include a base 11, a support plate 13, and a fixing plate 15. The support plate 13 and the fixing plate 15 can be secured at opposite ends of the base 11, respectively. The base 11 can include a seat 113 and two sidewalls 115 opposite to each other. The sidewalls 115 can be coupled to opposite sides of the seat 113. In the illustrated embodiment, the seat 113 can be substantially U-shaped and each sidewall 115 can be substantially L-shaped. The support plate 13 and the fixing plate 15 can be parallel to each other. The base 11, the support plate 13 and the fixing plate 15 can define a receiving chamber 17, cooperatively.

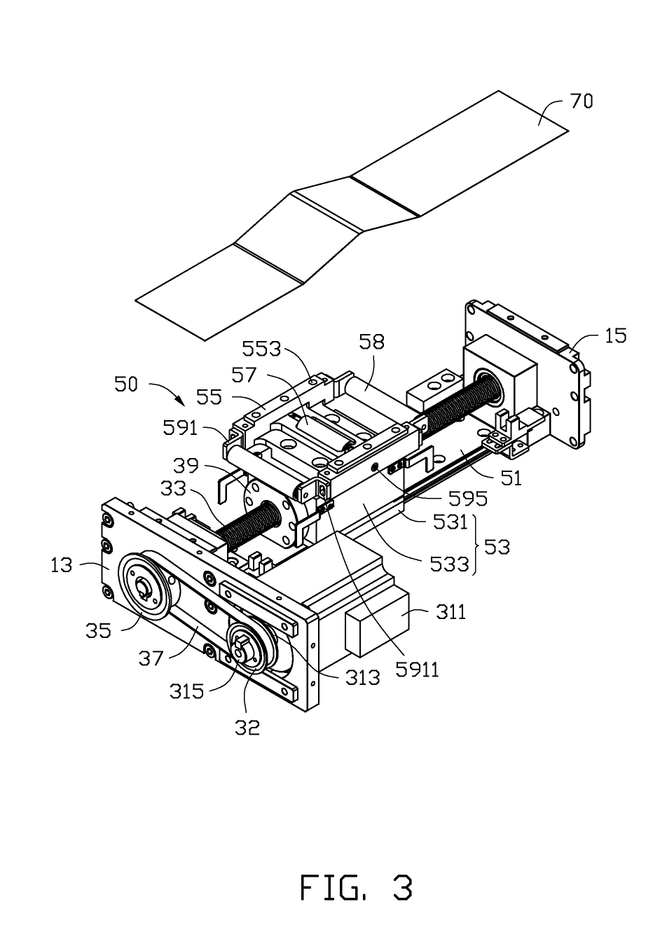

FIG. 3 shows that the driving mechanism 30 can include a driver 31 (shown in FIG. 1), a first pulley 32, a screw lead 33, a second pulley 35, a transmission belt 37, a protection cover 38 (shown in FIG. 2), and a transmission member 39. The driver 31 can be coupled to the frame 10 and include a driving body 311, a driving shaft 313 coupled to the driving body 311, and an output shaft 315 non-rotatably coupled to the driving shaft 313. The driving body 311 can be fixed to the support plate 13. The output shaft 315 can pass through the support plate 13. The first pulley 32 can be sleeved on the output shaft 315 of the driver 31 and located at a side of the support plate 13 away from the fixing plate 15. The first pulley 32 can rotate driven by the driver 31. The screw lead 33 can rotatably coupled to the support plate 13 and the fixing plate 15 and an end portion adjacent to the support plate 13 can protrude out of the support plate 13. The screw lead 33 can be perpendicular to the support plate 13 and the fixing plate 15, and parallel to the output shaft 315.

The second pulley 35 can be sleeved on the end portion of the screw lead 33 and located at the side of the support plate 13 same with the first pulley 32. The second pulley 35 can rotate the screw lead 33. The transmission belt 37 can wind on the first pulley 32 and the second pulley 35, such that the first pulley 32 can rotate the second pulley 35. The transmission member 39 can be sleeved on the screw lead 33 and received in the receiving chamber 17. The transmission member 39 can thread with the screw lead 33. When the screw lead 33 is rotated, the transmission member 39 can move along the screw lead 33. The protection cover 38 can be secured on the support plate 13 and cover the first pulley 32 and the second pulley 35, to prevent the first pulley 32 and the second pulley 35 from exposing outside.

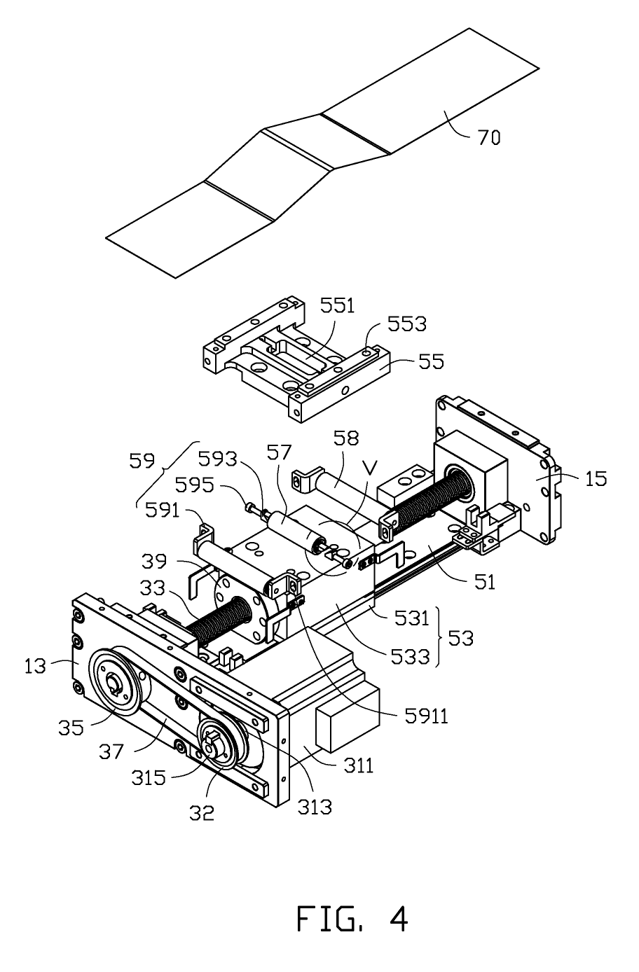

FIG. 4 illustrates that the guiding mechanism 50 can include a guiding rail 51, a platform 53, a guiding frame 55, a first guiding roller 57, two second guiding roller 58, and an adjusting assembly 59. The guiding rail 51 can be mounted on the seat 113 and received in the receiving chamber 17. The guiding rail 51 can be parallel to the screw lead 33. The platform 53 can be slidably coupled to the guiding rail 51 and sleeved on the screw lead 33. The platform 53 can include a slide portion 531 and a support portion 533 fixed to the slide portion 531. The slide portion 531 can be slidably coupled to the guiding rail 51. The support portion 533 can be a substantially hollow cuboid and movably sleeved on the screw lead 33. The support portion 533 can be fixed with the transmission member 39. The support portion 533 can slide along the screw lead 33 together with the transmission member 39, such that the slide portion 531 can slide along the guiding rail 51.

The guiding frame 55 can be substantially in “II” shaped and mounted on the support member 533. The guiding frame 55 can define a concave portion 551 at substantially a center thereof, and can define three coupling holes 553 at each of opposite ends thereof. The three coupling holes 553 at each end of the guiding frame 55 can be arranged at a straight line parallel to the screw lead 33. The first guiding roller 57 and the two second guiding rollers 58 can be arranged spaced and parallel to each other on the guiding frame 55. Each of the first guiding roller 57 and the second guiding rollers 58 can be substantially perpendicular to the screw lead 33. The first guiding roller 57 can be received in the concave portion 551 of the guiding frame 55. The second guiding rollers 58 can be respectively positioned at opposite side of the first guiding roller 57.

The hermetic band 70 can wind on the first guiding roller 57 and the second guiding rollers 58. Two end portions of the hermetic band 70 can be respectively coupled to the support plate 13 and the fixing plate 15. Two side edges of the hermetic band 70 can be abut against the sidewalls 115 of the base 11, respectively, for sealing the receiving chamber 17. The hermetic band 70 can be configured to avoid dusts, oil, or water to enter into the receiving chamber 17.

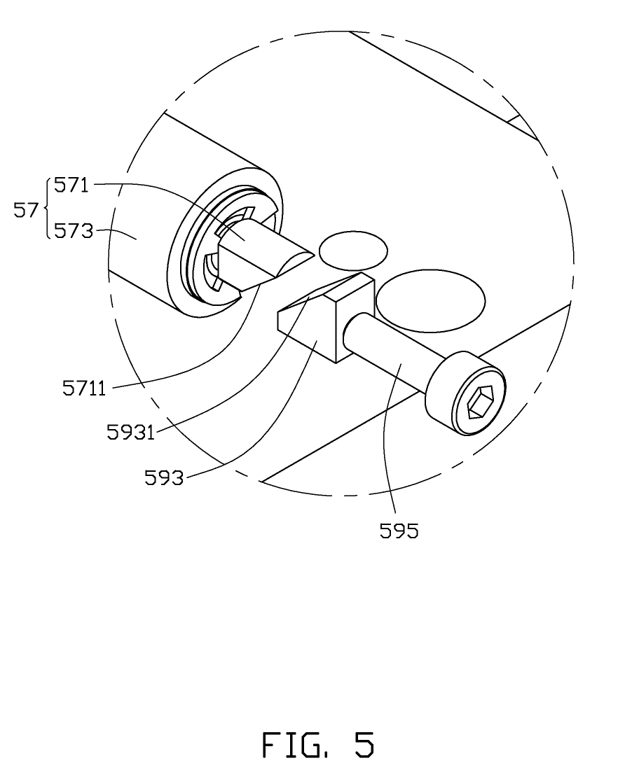

FIG. 5 illustrates that the first guiding roller 57 can include a shaft 571 and a rotatable portion 573 rotatably sleeved on the shaft 571. The shaft 571 can be arranged along a center axis of the first guiding roller 57. The shaft 571 can be substantially a rod being cut at opposite ends to form a first inclined surface 5711 at each end thereof. The rotatable portion 573 can be substantially cylindrical.

The adjusting assembly 59 can include four adjusting frames 591 (shown in FIG. 4), two adjusting blocks 593, and at least one adjusting member 595. The adjusting frames 591 can be respectively coupled to four corner portions of the guiding frame 55 and configured to adjustably couple the second guiding rollers 58 to the guiding frame 55. In the illustrated embodiment, each adjusting frame 591 can be substantially L-shaped. A first end portion of each adjusting frame 591 can be coupled to a second guiding roller 58, and a second end portion of the adjusting frame 591 can be coupled to the guiding frame 55.

Each adjusting frame 591 can define a slotted hole 5911 adjacent to the guiding frame 55. A longitudinal direction of the slotted hole 5911 can be substantially perpendicular to the guiding frame 55. The slotted hole 5911 can be configured to adjust a height of the second guiding roller 58 relative to the guiding frame 55. When a height of the second guiding roller 58 needs to be adjusted, the second guiding roller 58 can be manually lifted up and fixed with the guiding frame 55 again. In at least one embodiment, the second guiding roller 58 can be fixed to the guiding frame 55 by a screw (not shown), such that the screw can be detached and engage with the slotted hole 5911 at a different height to adjust a height of the second guiding roller 58.

The adjusting blocks 593 can be respectively mounted at opposite ends of the shaft 571 of the first guiding roller 57. Each adjusting block 593 can be substantially a block being cut to form a second inclined surface 5931. The second inclined surface 5931 can be positioned adjacent to an end portion of the shaft 571 and resist the adjacent first inclined surface 5711 of the shaft 571. The at least one adjusting member 595 can pass through the guiding frame 55 and adjustably coupled to the guiding frame 55. In the illustrated embodiment, the guiding frame 55 can thread with the guiding frame 55.

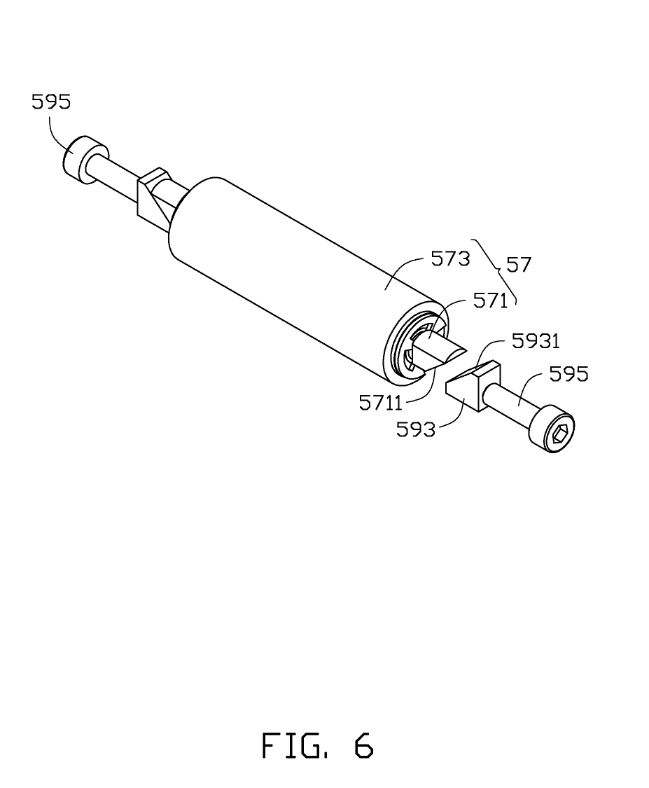

FIG. 6 shows that, in the illustrated embodiment, a number of the adjusting member 595 can be two and each adjusting member 595 can be coupled to one of the adjusting blocks 593. An end portion of each adjusting member 595 received in the guiding frame 55 can be coupled to the adjusting block 393 adjacent to the adjusting member 595. The adjusting member 595 can push the adjusting block 393, such that the first inclined surface 5711 can move along the second inclined surface 5931 to lift the first guiding roller 57 upward.

In the illustrated embodiment, the hermetic band 70 can be assembled to the frame 10 in steps as follows. First, a first end portion of the hermetic band 70 can be coupled to the fixing plate 15. Second, a second end portion of the hermetic band 70 can be pulled towards the guiding frame 55 and pass through a bottom of one of the second guiding rollers 58 adjacent to the fixing plate 15. Third, the hermetic band 70 can be pulled along a direction parallel to the screw lead 33 and wind on a top of the first guiding roller 57. Fourth, the second end portion of the hermetic band 70 can pass through a bottom of another second guiding roller 58 adjacent to the support plate 13. Fifth, the second end portion of the hermetic band 70 can be coupled to the support plate 13. Thus, the driving mechanism 30 can be covered by the hermetic band 60.

The second guiding rollers 58 can abut against an outer surface of the hermetic band 70 towards the platform 53. The first guiding roller 57 can abut against an inner surface of the hermetic band 70 away from the platform 53. In at least one embodiment, the second guiding rollers 58 can abut against an inner surface of the hermetic band 70 and the first guiding rollers 58 can abut against an outer surface of the hermetic band 70. In the illustrated embodiment, the hermetic band 70 can be steel band. The protective cover 80 can be coupled to the guiding frame 55 and cover the guiding frame 55.

In assembly, the guiding rail 51 can be mounted on the base 11. The transmission member 39 can be sleeved on the screw lead 33 and the platform 53 can be coupled to the transmission member 39. The screw lead 33 can be mounted between the support plate 13 and the fixing plate 15. The driver 31 can be mounted on the support plate 13. The first pulley 32 can be sleeved on the output shaft 315. The second pulley 35 can be sleeved on the screw lead 33. The transmission belt 37 can wind on the first pulley 32 and the second pulley 35. The guiding frame 55 can be mounted on the platform 53. The first guiding roller 57 and the second guiding rollers 58 can be coupled to the guiding frame 55. The hermetic band 70 can be coupled to the frame 10 and wind on the first guiding roller 57 and second guiding rollers 58. The protective cover 80 can cover the guiding frame 55.

In use, a workpiece can be put on the protective cover 80 and fastened to the protective cover 80 or/and the coupling holes 553 of the guiding frame 55. The first driver 31 can rotate the first pulley 32, the second pulley 35, and the screw lead 33. The transmission member 39 and the guiding frame 55 can move along the screw lead 33, such that the workpiece can move linearly. The first guiding roller 57 and the second guiding rollers 58 can roll. When a height of the first guiding roller 57 or the second guiding rollers 58 is adjusted, a tension of the hermetic band 70 can be adjusted.

In at least one embodiment, the driving mechanism 30 can be other structures, such as the driver 31 can directly rotate the screw lead 33 and the first pulley 32, the second pulley 35, and the transmission belt 37 can be omitted. The platform 53 can be designed to directly thread with the screw lead 33, thus the transmission member 39 can be omitted. When a number of the adjusting member 595 is one, then one of the two adjusting blocks 593 can be coupled to the guiding frame 55.

The embodiments shown and described above are only examples. Many details are often found in the art such as the other features of a single axis robot. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A single axis robot comprising:
a frame;
a driving mechanism coupled to the frame;
a guiding mechanism coupled to the driving mechanism and configured to be linearly driven by the driving mechanism, the guiding mechanism comprising:
a platform coupled to the driving mechanism,
a guiding frame mounted on the platform,
a first guiding roller and two second guiding rollers arranged spaced and parallel to each other on the guiding frame, the second guiding rollers positioned at opposite sides of the first guiding roller, the first guiding roller comprising a shaft and a rotatable portion rotatably sleeved on the shaft, the shaft having a first inclined surface at each end thereof, and
an adjusting assembly comprising two adjusting blocks respectively positioned at opposite ends of the shaft and at least one adjusting member, the at least one adjusting member adjustably coupled to the guiding frame and fixed to the corresponding adjusting block, each adjusting block having a second inclined surface resisting the first inclined surface; and
a hermetic band coupled to the frame and winding on the first guiding roller and the second guiding rollers to seal the frame.

2. The single axis robot of claim 1, wherein the second guiding rollers abut against an outer surface of the hermetic band, the first guiding roller abuts against an inner surface of the hermetic band.

3. The single axis robot of claim 1, wherein the adjusting assembly further comprises four adjusting frames, a first end portion of each adjusting frame is coupled to one of the second guiding rollers, and a second end portion of the adjusting frame is coupled to the guiding frame.

4. The single axis robot of claim 3, wherein each adjusting frame defines a slotted hole, a longitudinal direction of the slotted hole is substantially perpendicular to the guiding frame.

5. The single axis robot of claim 1, wherein the guiding frame defines a concave portion at substantially a center thereof, the first guiding rod is received in the concave portion.

6. The single axis robot of claim 1, wherein a number of the at least one adjusting member is two, each adjusting member thread with the guiding frame and is coupled to one of the adjusting blocks.

7. The single axis robot of claim 1, wherein the frame comprises a base, a support plate, and a fixing plate, the support plate and the fixing plate are secured at opposite ends of the base, respectively, the base, the support plate and the fixing plate define a receiving chamber, cooperatively.

8. The single axis robot of claim 7, wherein the base comprises a seat and two sidewalls, the sidewalls are coupled to opposite sides of the seat, two end portions of the hermetic band are respectively coupled to the support plate and the fixing plate, two side edges of the hermetic band abut against the sidewalls of the base, respectively, the hermetic band is configured to seal the receiving chamber.

9. The single axis robot of claim 8, wherein the driving mechanism comprises a driver and a screw lead coupled to the driver, the driver is coupled to the support plate, the screw lead rotatably coupled to the support plate and the fixing plate.

10. The single axis robot of claim 9, wherein the guiding mechanism further comprises a guiding rail mounted on the seat and received in the receiving chamber, the guiding rail is parallel to the screw lead, the platform is slidably coupled to the guiding rail and sleeved on the screw lead.

11. The single axis robot of claim 10, wherein the platform comprises a slide portion and a support portion fixed to the slide portion, the slide portion is slidably coupled to the guiding rail, the support portion is movably sleeved on the screw lead and fixed with the transmission member, the guiding frame is coupled to the support portion.

12. The single axis robot of claim 1 further comprising a protective cover, wherein the protective cover covers and protects the guiding mechanism.

13. A single axis robot comprising:
a frame;
a driving mechanism coupled to the frame;
a guiding mechanism coupled to the driving mechanism and configured to be linearly driven by the driving mechanism, the guiding mechanism comprising:
a platform coupled to the driving mechanism,
a guiding frame mounted on the platform,
a first guiding roller and two second guiding rollers arranged spaced and parallel to each other on the guiding frame, the second guiding rollers positioned at opposite sides of the first guiding roller, the first guiding roller having a first inclined surface at each end thereof, and
an adjusting assembly comprising two adjusting blocks and two adjusting members, each adjusting member adjustably coupled to the guiding frame and fixed to one of the adjusting blocks, each adjusting block having a second inclined surface resisting the first inclined surface; and
a hermetic band coupled to the frame and winding on the first guiding roller and the second guiding rollers to seal the frame.

14. The single axis robot of claim 13, wherein the second guiding rollers abut against an outer surface of the hermetic band, the first guiding roller abuts against an inner surface of the hermetic band.

15. The single axis robot of claim 13, wherein the adjusting assembly further comprises four adjusting frames, a first end portion of each adjusting frame is coupled to one of the second guiding rollers, and a second end portion of the adjusting frame is coupled to the guiding frame.

16. The single axis robot of claim 15, wherein each adjusting frame defines a slotted hole, a longitudinal direction of the slotted hole is substantially perpendicular to the guiding frame.

17. The single axis robot of claim 13, wherein the frame comprises a base, a support plate, and a fixing plate, the support plate and the fixing plate are secured at opposite ends of the base, respectively, the base, the support plate and the fixing plate define a receiving chamber, cooperatively.

18. The single axis robot of claim 17, wherein the base comprises a seat and two sidewalls, the sidewalls are coupled to opposite sides of the seat, two end portions of the hermetic band are respectively coupled to the support plate and the fixing plate, two side edges of the hermetic band abut against the sidewalls of the base, respectively, the hermetic band is configured to seal the receiving chamber.

19. The single axis robot of claim 13, wherein each adjusting member thread with the guiding frame.

20. The single axis robot of claim 13, wherein each adjusting member is configured to push the corresponding adjusting block, such that the first inclined surface moves along the second inclined surface to lift the first guiding roller upward.
